(19) United States
(12) Patent Application Publication
(10) Pub. No.: US 2025/0218681 A1
(43) Pub. Date: Jul. 3, 2025

(54) MULTILAYER ELECTRONIC COMPONENT

(71) Applicant: SAMSUNG ELECTRO-MECHANICS CO., LTD., Suwon-si (KR)

(72) Inventors: Jun Il Song, Suwon-si (KR); Dong Uk Kim, Suwon-si (KR); Dong Kyu Lee, Suwon-si (KR)

(73) Assignee: SAMSUNG ELECTRO-MECHANICS CO., LTD., Suwon-si (KR)

(21) Appl. No.: 18/952,504

(22) Filed: Nov. 19, 2024

(30) Foreign Application Priority Data
Dec. 28, 2023 (KR) 10-2023-0194500

(51) Int. Cl. H01G 4/232; H01G 4/30

(52) U.S. Cl. CPC H01G 4/232; H01G 4/30

(57) ABSTRACT

A multilayer electronic component according to an example embodiment may include: a body including a stack unit including a dielectric layer and internal electrodes alternately arranged in a first direction with the dielectric layer interposed therebetween, when a direction, perpendicular to the first direction, is referred to as a second direction, and a direction perpendicular to the first direction and the second direction, is referred to as a third direction, connection electrodes disposed on surfaces of the stack unit opposing each other in the second direction and in contact with the internal electrode, and an extension unit disposed on the connection electrode and including an insulating layer; and external electrodes disposed on the body, and the extension unit further includes via electrodes in contact with at least a portion of the connection electrode and the external electrode.

### CROSS-REFERENCE TO RELATED APPLICATION(S)

This application claims benefit of priority to Korean Patent Application No. 10-2023-0194500 filed on Dec. 28, 2023, in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser, mounted on the printed circuit boards of various types of electronic products, such as image display devices including a liquid crystal display (LCD) and a plasma display panel (PDP), computers, smartphones and mobile phones, and serves to charge electricity therein or discharge electricity therefrom.

The multilayer ceramic capacitor may be used as a component in various electronic devices due to having a small size, ensuring high capacitance and being easily mounted. With the miniaturization and implementation of high output power of various electronic devices such as computers and mobile devices, demand for miniaturization and high capacitance of multilayer ceramic capacitors has also been increasing.

Additionally, as industry interest in automotive electrical components has recently increased, a multilayer ceramic capacitor is also required to have high reliability characteristics in order to be used in automobiles or vehicle infotainment systems.

Conventional multilayer ceramic capacitors have a structure in which internal electrodes and dielectric layers are stacked, one end of the internal electrode is exposed in a direction, perpendicular to the stacking direction, and the exposed end of the internal electrode is in contact with an external electrode.

Since the exposed end of the internal electrode is close to a corner of the body or a band portion of the external electrode, this may act as a major pathway for oxygen or moisture to penetrate. Additionally, when a plurality of internal electrodes are stacked, an area in which ends of a plurality of internal electrodes and the external electrodes contact each other not be sufficiently secured, which may increase the equivalent series resistance (ESR) of the multilayer ceramic capacitor.

Accordingly, there need for structural improvement in a multilayer electronic component that may prevent the penetration of oxygen or moisture while improving a contact area between the internal electrodes and the external electrodes.

### SUMMARY

An aspect of the present disclosure is to solve the problem of difficulty in securing connectivity between an internal electrode and an external electrode when one end of the internal electrode is in direct contact with the external electrode.

An aspect of the present disclosure is to solve the problem of vulnerability to moisture or oxygen infiltration when one end of an internal electrode is in direct contact with an external electrode.

However, the aspects of the present disclosure are not limited to the above-described contents, and may be more easily understood in the process of describing specific embodiments of the present disclosure.

A multilayer electronic component according to an example embodiment of the present disclosure may include: a body including a stack unit including a dielectric layer and internal electrodes alternately arranged in a first direction with the dielectric layer interposed therebetween, when a direction, perpendicular to the first direction, is referred to as a second direction, and a direction, perpendicular to the first direction and the second direction, is referred to as a third direction, a connection electrode disposed on surfaces of the stack unit opposing each other in the second direction and in contact with the internal electrode, and an extension unit disposed on the connection electrode and including an insulating layer; and external electrodes disposed on the body, and the extension unit further may include a via electrode in contact with at least a portion of the connection electrode and the external electrode.

One of the various effects of the present disclosure is to improve the moisture resistance reliability of a multilayer electronic component by minimizing the penetration of external moisture and oxygen into an internal electrode.

One of the various effects of the present disclosure is to improve the moisture resistance reliability of a multilayer electronic component by connecting an connection electrode and an external electrode through a via electrode, while securing excellent ESR characteristics, in a multilayer electronic component having a structure in which the internal electrode and the external electrode are connected through the connecting electrode,

Advantages and effects of the present disclosure are not limited to the foregoing content and may be more easily understood in the process of describing a specific example embodiment of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an example embodiment of the present disclosure;

FIG. 2 schematically illustrates a perspective view of a stack unit according to an example embodiment;

FIG. 3 schematically illustrates an exploded perspective view of a stack unit according to an example embodiment;

FIG. 4 is a perspective view schematically illustrating a body according to an example embodiment;

FIG. 5 schematically illustrates an exploded perspective view of a body according to an example embodiment;

FIG. 6 is a cross-sectional view taken along line I-I′ in FIG. 1;

FIG. 7 is a cross-sectional view taken along line II-II′ in FIG. 1;

FIG. 8 is a plan view schematically illustrating a structure of a connection electrode according to an example embodiment;

FIG. 9 is a plan view schematically illustrating a structure of a connection electrode according to an example embodiment;

FIG. 10 is a plan view schematically illustrating a structure of a connection electrode according to an example embodiment;

FIG. 11 is a plan view schematically illustrating a structure of a connection electrode according to an example embodiment; and

FIG. 12 is a plan view schematically illustrating a structure of a connection electrode according to an example embodiment.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. The example embodiments disclosed herein are provided for those skilled in the art to better explain the present disclosure. Therefore, in the drawings, the shapes and dimensions of elements may be exaggerated for clarity, and the same reference numerals will be used throughout to designate the same or like elements.

In addition, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. In addition, components with the same function within the same range of ideas are described using the same reference numerals. Throughout the specification, when certain portion “includes” or “comprises” a certain component, this indicates that other components are not excluded and may be further included unless otherwise noted.

In the drawings, a first direction may be defined as a stacking direction or a thickness (T) direction, a second direction may be defined as a length (L) direction, and a third direction may be defined as a width (W) direction.

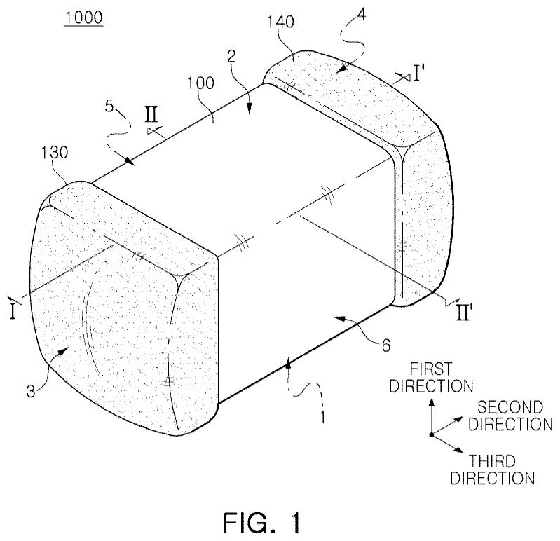

FIG. 1 is a perspective view schematically illustrating a multilayer electronic component according to an example embodiment of the present disclosure.

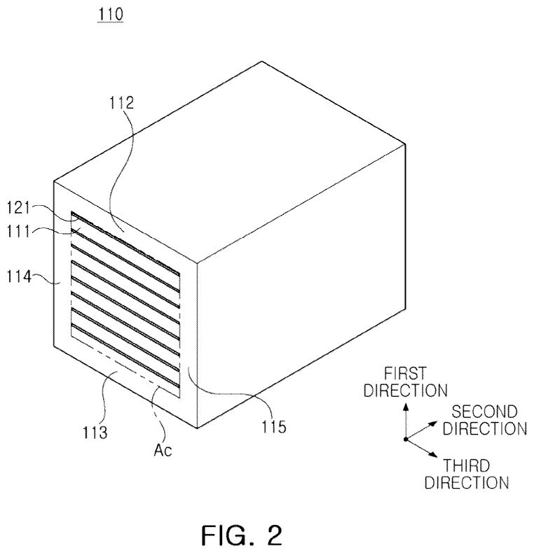

FIG. 2 schematically illustrates a perspective view of a stack unit according to an example embodiment.

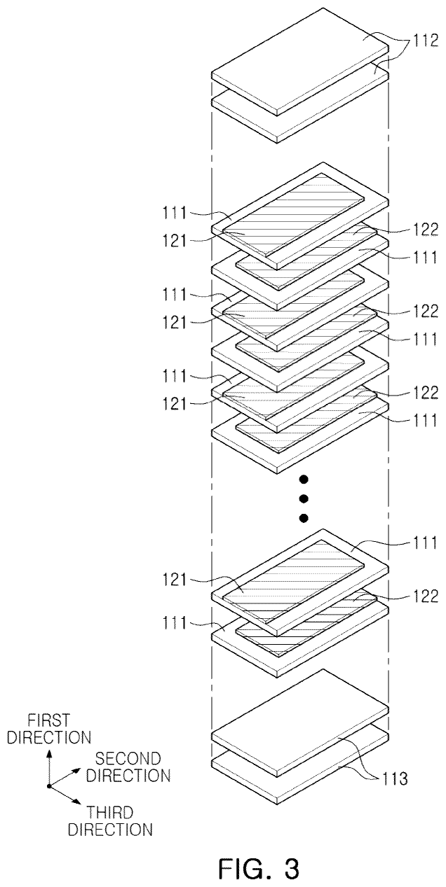

FIG. 3 schematically illustrates an exploded perspective view of a stack unit according to an example embodiment.

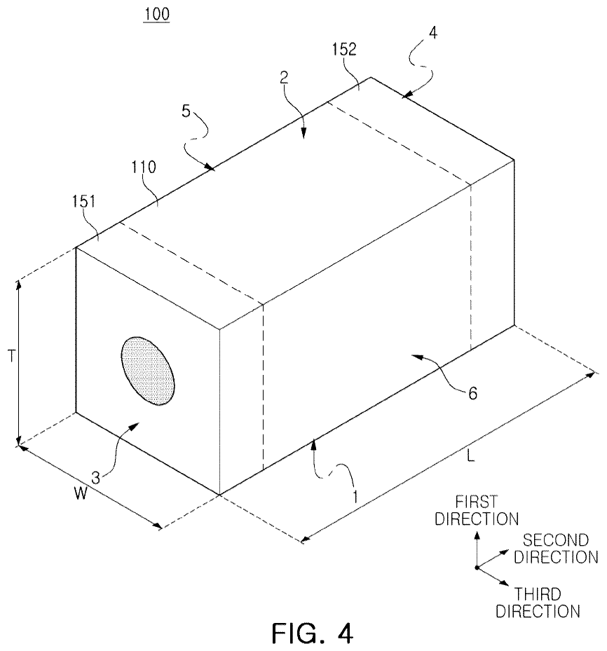

FIG. 4 is a perspective view schematically illustrating a body according to an example embodiment.

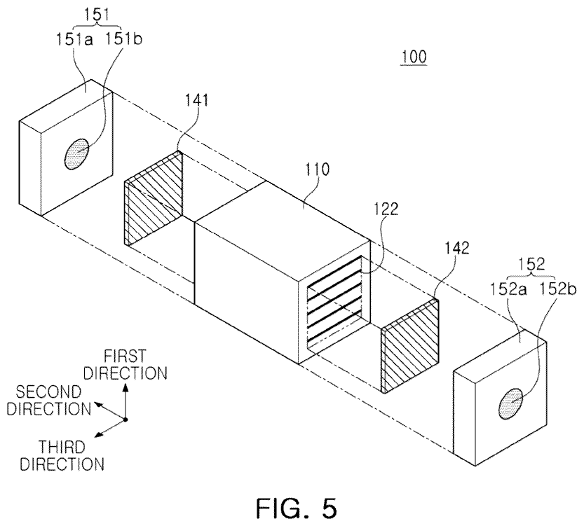

FIG. 5 schematically illustrates an exploded perspective view of a body according to an example embodiment.

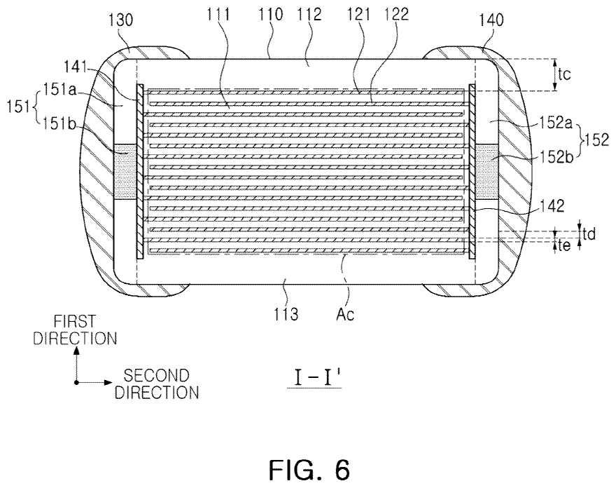

FIG. 6 is a cross-sectional view taken along line I-I′ in FIG. 1.

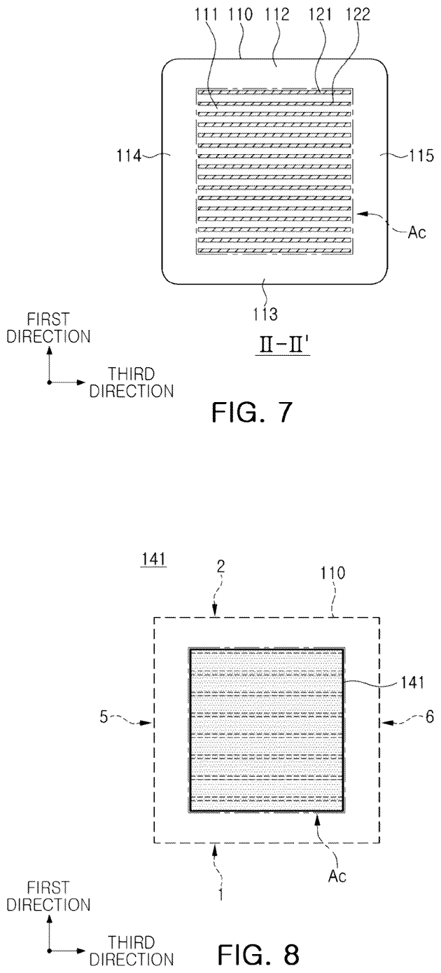

FIG. 7 is a cross-sectional view taken along line II-II′ in FIG. 1.

FIG. 8 is a plan view schematically illustrating a structure of a connection electrode according to an example embodiment.

Hereinafter, a multilayer electronic component 1000 according to an example embodiment of the present disclosure will be described in detail with reference to FIGS. 1 to 8.

The multilayer electronic component 1000 according to an example embodiment of the present disclosure may include: a body 100 including a stack unit 110 including a dielectric layer 111 and internal electrodes 121 and 212 alternately disposed in a first direction with the dielectric layer 111 interposed therebetween, when a direction, perpendicular to the first direction, is referred to as a second direction, and a direction, perpendicular to the first direction and the second direction, is referred to as a third direction, connection electrodes 141 and 142 disposed on surfaces of the stack unit 110 opposing each other in the direction and in contact with the internal electrodes 121 and 122, and extension units 151 and 152 disposed on the connection electrodes 141 and 142 and including insulating layers 151a and 152a; and external electrodes 130 and 140 disposed on the body 100, and the extension units 151 and 152 may further include via electrodes 151b and 152b contacting at least portions of the connection electrodes 141 and 142 and the external electrodes 130 and 140.

Referring to FIGS. 2 and 3, the stack unit 110 may include the dielectric layer 111 and the internal electrodes 121 and 122. The internal electrodes 121 and 122 may be alternately disposed in the first direction with the dielectric layer 111 interposed therebetween.

In a state in which a plurality of dielectric layers 111 forming the stack unit 110 are sintered, boundaries between adjacent dielectric layers 111 may be integrated to such an extent as to be difficult to identify without using a scanning electron microscope (SEM).

A material for forming the dielectric layer 111 is not particularly limited as long as a sufficient electrostatic capacitance may be obtained therewith. For example, a barium titanate-based dielectric material, a CaZrO₃-based dielectric material, and the like, may be used as the material. For example, the barium titanate-based (BaTiO₃)-based dielectric material may be one or more of BaTiO₃, (Ba₁₋ₓCaₓ)TiO₃ (0<x<1), Ba(Ti_{1-y}Ca_{y})O₃ (0<x<1), (Ba₁₋ₓCaₓ) (Ti_{1-y}Zr_{y})O₃ (0<x<1, 0<y<1) and Ba(Ti_{1-y}Zr_{y})O₃ (0<y<1), and a CaZrO₃-based ferroelectric dielectric material may be (Ca₁₋ₓSrₓ)(Zr_{1-y}Ti_{y})O₃ (0<x<1, 0<y<1).

Additionally, various ceramic additives, organic solvents, binders, dispersants, and the like, may be added to the dielectric layer 111 according to the purpose of the present disclosure.

An average thickness td of the dielectric layer 111 is not particularly limited.

In order to implement miniaturization and high capacitance of the multilayer electronic component 1000, an average thickness td of the dielectric layer 111 may be 0.35 μm or less, and in order to improve reliability of the multilayer electronic component 1000 under high temperature and high voltage, the average thickness td of the dielectric layer 111 may be 3 μm or more.

The average thickness td of the dielectric layer 111 may be measured by scanning an image of a third and first directional cross-section (L-T cross-section) of the body 100 with a scanning electron microscope (SEM).

For example, with respect to a total of five dielectric layers, two layers to an upper portion and two layers to a lower portion based on a first layer of the dielectric layer at a point at which a longitudinal center line of the body meets a thickness-direction center line thereof among the dielectric layers extracted from an image of a length and thickness direction (L-T) cross-section obtained by cutting a center of the body 100 in a width direction scanned by the scanning electron microscope (SEM), the average thickness td of the dielectric layer 111 may be measured by setting, to equal intervals, five points, that is, two points to the left and two points to the right, centered on the one reference point and then measuring thicknesses of each point, based on the point at which the longitudinal center line of the body meets the thickness-direction center line thereof.

The internal electrodes 121 and 122 may include a first internal electrode 121 and a second internal electrode 122.

The first and second internal electrodes 121 and 122 may be alternately disposed to face each other with the dielectric layer 111 interposed therebetween, and the first internal electrode 121 may be exposed to one surface of the stack unit 110 in the second direction, and the second internal electrode 122 may be exposed to the other surface of the stack unit 110 in the second direction.

Referring to FIG. 6, the first internal electrode 121 may be spaced apart from the other surface of the stack unit 110 in the second direction by a predetermined distance, and the second internal electrode 122 may be spaced apart from one surface of the stack unit 110 in the second direction by a predetermined distance. In this case, the first and second internal electrodes 121 and 122 may be electrically separated from each other by the dielectric layer 111 disposed therebetween.

The stack unit 110 may be formed by alternately stacking a ceramic green sheet on which the first internal electrode 121 is printed and a ceramic green sheet on which the second internal electrode 122 is printed, and then sintering the ceramic green sheets.

A material for forming the internal electrodes 121 and 122 is not particularly limited, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

Additionally, the internal electrodes 121 and 122 may be formed by printing a conductive paste for internal electrodes, including one or more of nickel (Ni), copper (Cu), palladium (Pd), silver (Ag), gold (Au), platinum (Pt), tin (Sn), tungsten (W), titanium (Ti), and alloys thereof, on the ceramic green sheet. A printing method of the conductive paste for internal electrodes may be a screen-printing method or a gravure printing method, and the present disclosure is not limited thereto.

An average thickness te of the internal electrodes 121 and 122 is not particularly limited and may vary according to a purpose. In order to miniaturize the multilayer electronic component 1000, the average thickness te of the internal electrodes 121 and 122 may be 0.35 μm or less, and in order to improve reliability of the multilayer electronic component 1000 under high temperature and high voltage, the average thickness te of the internal electrodes 121 and 122 may be 3 μm or more.

With respect to a total of five internal electrodes, two layers to an upper portion and two layers to a lower portion based on a first layer of the internal electrode at a point at which a longitudinal center line of the body meets a thickness-direction center line thereof among the internal electrodes extracted from an image of a length and thickness direction (L-T) cross-section obtained by cutting a center of the body 100 in a width direction scanned by the scanning electron microscope (SEM), an average thickness te of the internal electrode 121 and 122 may be measured by setting, to equal intervals, five points, that is, two points to the left and two points to the right, centered on the one reference point and then measuring thicknesses of each point, based on the point at which the longitudinal center line of the body meets the thickness-direction center line thereof.

Referring to FIG. 2 and FIG. 6, in the stack unit 110, a region in which the internal electrodes 121 and 122 overlap each other in the first direction may be defined as a capacitance formation portion Ac.

The capacitance formation portion Ac may serve to form electrostatic capacitance as the first and second internal electrodes 121 and 122 are disposed to overlap each other in the first direction.

Meanwhile, cover portions 112 and 113 may be included on one surface and the other surface of the capacitance formation portion Ac in the first direction.

The cover portions 112 and 113 may be formed by stacking a single dielectric layer or two or more dielectric layers on upper and lower surfaces of the capacitance formation portion Ac in a thickness direction, respectively, and may basically serve to prevent damage to the internal electrodes due to physical or chemical stress.

The cover portions 112 and 113 may not include the internal electrodes and may include the same material as the dielectric layer 111. That is, the cover portions 112 and 113 may include a ceramic material, and may include, for example, the same material as the dielectric layer 111.

Meanwhile, a thickness of the cover portions 112 and 113 does not need to be particularly limited. For example, a thickness tc of the cover portions 112 and 113 may be 20 μm or less, respectively.

The average thickness tc of the cover portions 112 and 113 may refer to a first directional size, and may be an average value of the first directional sizes of the cover portions 112 and 113 measured at five points spaced apart from each other by equal intervals in an upper portion or a lower portion of the capacitance formation portion Ac.

Width-margin portions 114 and 115 may be disposed on one surface and the other surface of capacitance formation portion Ac in the third direction.

As illustrated in FIG. 2, the width-margin portions 114 and 115 may refer to regions between both ends of the first and second internal electrodes 121 and 122 in the third direction and a boundary surface of the stack unit 110, in second directional cross-sections (end surfaces) of the stack unit 110.

The width-margin portions 114 and 115 may basically serve to prevent damage to the internal electrodes due to physical or chemical stress.

The width-margin portions 114 and 115 may be formed by forming the internal electrodes by applying a conductive paste except for a region in which the margin portion is to be formed on the ceramic green sheet.

Additionally, in order to suppress a step portion caused by the internal electrodes 121 and 122, the internal electrodes may be stacked and may then be cut to be exposed to both end surfaces of the stack unit in the third direction, and then a single dielectric layer or two or more dielectric layers may be stacked on both side surfaces of the capacitance formation portion Ac in the third direction (width direction), thus forming the width-margin portions 114 and 115.

Meanwhile, a width of the width-margin portions 114 and 115 need not be particularly limited. For example, the average width of the width-margin portions 114 and 115 may be 20 μm or less, respectively.

An average width of the width-margin portions 114 and 115 may refer to a third-direction average size of a region in which the internal electrode is spaced apart from the fifth surface, and a third-direction average size of a region in which the internal electrode is spaced apart from the sixth surface, and may be an average value of the third directional sizes of the width-margin portions 114 and 115 measured at five points spaced apart from each other by equal intervals on the side surface of the capacitance formation portion Ac.

A length-margin portion may be disposed on one surface and the other surface of the capacitance formation portion Ac in the second direction. Specifically, as illustrated in FIG. 6, the length-margin portion may refer to a region between both ends of the first and second internal electrodes 121 and 122 in the second direction and both end surfaces of the stack unit 110 in the second direction.

The width-margin portions 114 and 115 may refer to an area between both ends of the first and second internal electrodes 121 and 122 in the second direction and both end surfaces of the stack unit 110 in the second direction, as illustrated in FIG. 6.

The length-margin portion may serve to connect the first internal electrode 121 and the second internal electrode 122 to power sources having different polarities, respectively. Meanwhile, the length-margin portion may include one of the first internal electrode 121 and the second internal electrode 122, and the dielectric layer 111, which may not contribute to the formation of capacitance, and the length-margin portion may include the first or second internal electrode exposed to the end surfaces of the stack unit 110, which may become a path for external moisture penetration.

Referring to FIG. 4, when a direction, perpendicular to the first direction, is referred to as a second direction, and a direction, perpendicular to the first direction and the second direction, is referred to as a third direction, the body 100 may include first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first and second surfaces 1 and 2 and connected to the third and fourth surfaces 3 and 4 and opposing each other in the third direction.

There is no particular limitation on a specific shape of the body 100, but as illustrated, the body 100 may have a hexahedral shape or a shape similar thereto. Due to contraction of the ceramic powder particles included in the body 100 during a sintering process, the body 100 may not have a hexahedral shape having an entirely straight line, but may have a substantially hexahedral shape.

Referring to FIG. 5, the body 100 may include connection electrodes 141 and 142 disposed on the surfaces of the stack unit 110 opposing each other in the second direction and in contact with the internal electrodes 121 and 122.

A method of printing the connection electrodes 141 and 142 on the extension units 151 and 152 may vary according to purpose. For example, in the case in which the connection electrodes 141 and 142 having various and complex forms should be printed, the connection electrodes 141 and 142 may be formed by screen-printing, but the present disclosure is not limited thereto.

The components of the connection electrodes 141 and 142 are not particularly limited, and may include the same conductive metal as the internal electrodes 121 and 122 or a different metal element from the conductive metal included in the internal electrodes 121 and 122.

Referring to FIG. 5, the body 100 may include extension units 151 and 152 disposed on connection electrodes. The extension units 151 and 152 may include insulating layers 151a and 152a to improve sealing characteristics and minimize the penetration of moisture or plating solution from the outside, and the extension units 151 and 152 may include via electrodes 151b and 152b to serve to connect all of the internal electrodes 121 and 122, the connection electrodes 141 and 142, and the external electrodes 130 and 140.

The extension units 151 and 152 may be disposed to cover cross-sections of the stack unit 110 and the connection electrodes 141 and 142 in the second direction, thereby improving sealability of the multilayer electronic component 1000. From this point of view, the extension units 151 and 152 may be disposed to cover both cross-sections of the connection electrodes 141 and 142 in the second direction.

Materials of the insulating layers 151a and 152a may include a barium titanate-based material, a lead composite perovskite-based material, or strontium titanate-based materials, but the present disclosure is not limited thereto. Since the extension units 151 and 152 do not contribute to the capacitance formation like the dielectric layer 111, the extension units 151 and 152 are not necessarily formed of a material having high dielectric constant, and may include materials having excellent sealing properties, strength, and adhesive force.

The via electrodes 151b and 152b may be formed by forming a via hole with a drill or laser in the insulating layers 151a and 152a and filling the via hole with a conductive material. The via electrodes 151b and 152b may be disposed to penetrate the insulating layers 151a and 152a in the second direction, thus simultaneously connecting the external electrodes 130 and 140 and the connection electrodes 141 and 142.

The extension units 151 and 152 may be formed in a transfer manner, similarly to the connection electrodes 141 and 142, and may then be subjected to a sintering process. Furthermore, the stack unit 110 and the connection electrodes 141 and 142 may be simultaneously sintered.

The external electrodes 130 and 140 may be disposed on the body 100 and connected to the via electrodes 151b and 152b.

The external electrodes 130 and 140 may be formed of any material as long as the material has electrical conductivity such as a metal, and a specific material may be determined in consideration of electrical properties, structural stability, or the like, and the external electrodes 130 and 140 may further have a multilayer structure.

For example, the external electrodes 130 and 140 may include an electrode layer disposed on the body 100 and a plating layer formed on the electrode layer.

For a more specific example of the electrode layer, the electrode layer may be a sintered electrode including a conductive metal and glass, or a resin-based electrode including a conductive metal and a resin.

Additionally, the external electrodes 130 and 140 may have a form in which the sintered electrode and the resin-based electrode are sequentially formed on the body 100. Furthermore, the external electrodes 130 and 140 may be formed of a sheet including a conductive metal on the body 100 in a dipping manner or a wheel method, but the present disclosure is not limited thereto.

A material having excellent electrical conductivity may be used as the conductive metal included in the external electrodes 130 and 140, but the present disclosure is not particularly limited thereto. For example, the conductive metal may be one or more of nickel (Ni), copper (Cu), palladium (Pd), and alloys thereof.

Conventionally, in multilayer electronic components, first and second internal electrodes and external electrodes have been brought into contact with each other on both surfaces of the stack unit 110 opposing each other in the second direction so that each of the first internal electrode 121 and the second internal electrode 122 may be connected to terminal electrodes of different polarities.

In this case, in order to increase the capacitance per unit volume of the multilayer electronic component, there is a need to minimize a length of the length-margin portion in the second direction that does not contribute to capacitance formation. However, as the length of the length-margin portion in the second direction decreases, a path of external moisture or oxygen penetration may be shorter, which may lead to a problem that moisture-resistant reliability becomes weak.

Accordingly, in an example embodiment of the present disclosure, the extension units 151 and 152 including the insulating layers 151a and 152a may be disposed on the connection electrodes 141 and 142 so that a length-margin portion may be formed to a minimum to improve the capacitance per unit volume of the multilayer electronic component 1000, and a penetration path of external moisture or oxygen may be increased to improve moisture resistance of the multilayer electronic component 1000.

Meanwhile, since the extension units 151 and 152 including the insulating layers 151a and 152a are disposed on the connection electrodes 141 and 142, ends of the connection electrodes 141 and 142 should be exposed to surfaces of the body 100 opposing each other in the first direction or surfaces of the body 100 opposing each other in the third direction so as to connect the connection electrodes 141 and 142 to the external electrodes 130 and 140 without the via electrodes 151b and 152b described below. In this case, since the first directional ends or the third directional ends of the connection electrodes 141 and 142 should be connected to the external electrodes 130 and 140, it may be difficult to secure a sufficient bonding area between the connection electrodes 141 and 142 and the external electrodes 130 and 140.

Accordingly, in an example embodiment of the present disclosure, the extension units 151 and 152 may further include via electrodes 151b and 152b in contact with at least portions of the connection electrodes 141 and 142 and the external electrodes 130 and 140, thereby improving the electrical connection between the connection electrodes 141 and 142 and the external electrodes 130 and 140, and improving ESR characteristics of the multilayer electronic component 1000.

In an example embodiment, the connection electrodes 141 and 142 may be spaced apart from one or more of surfaces 1 and 2 of body 100 opposing each other in the first direction and surfaces 5 and 6 of the body 100 opposing each other in the third direction.

According to an example embodiment of the present disclosure, since the via electrodes 151b and 152b are in direct contact with the external electrodes 130 and 140 and the connection electrodes 141 and 142 to secure electrical connectivity, the connection electrodes 141 and 142 need not be directly connected to the external electrodes 130 and 140. Accordingly, in an example embodiment, as the connection electrodes 141 and 142 are spaced apart from one or more of surfaces 1 and 2 of the body 100 opposing each other in the first direction and surfaces 5 and 6 of the body 100 opposing each other in the third direction, humidity resistance reliability of the multilayer electronic component 1000 may be improved.

In an example embodiment, the connection electrodes may be spaced apart from the surfaces of the body opposing each other in the first direction and the surfaces of the body opposing each other in the third direction of the body. Accordingly, as the connection electrodes 141 and 142 are spaced apart from both the surfaces 1 and 2 of the body 100 opposing each other in the first direction and the surfaces 5 and 6 of the body 100 opposing each other in the third direction, humidity resistance reliability of the multilayer electronic component 1000 may be further improved.

In an example embodiment, the via electrodes 151b and 152b may be included in plural in the extension units 151 and 152. Accordingly, an area in which the via electrodes 151b and 152b are in contact with the external electrodes 130 and 140 and the connection electrodes 141 and 142 may be improved to improve the ESR characteristics of the multilayer electronic component 1000.

In an example embodiment, a ratio of an area in which the via electrodes 151b and 152b contacts the surfaces 3 and 4 of the body 100 opposing each other in the second direction, as compared to an area of the surfaces 3 and 4 of body 100 opposing each other in the second direction, may be 15% or more and 65% or less. The surfaces 3 and 4 of the body 100 opposing each other in the second direction may be surfaces on which ends of the via electrodes 151b and 152b are exposed, and may be surfaces on which the external electrodes 130 and 140 and the via electrodes 151b and 152b are in contact with each other. In this case, when the ratio of the area in which the via electrodes 151b and 152b contact the surfaces 3 and 4 of the body 100 opposing each other in the second direction, as compared to the area of the surfaces 3 and 4 of the body 100 opposing each other in the second direction, is less than 158, an area in which the via electrodes 151b and 152b contact the external electrodes 130 and 140 and the connection electrodes 141 and 142 may be insufficient, which may make it difficult to improve ESR characteristics of the multilayer electronic component 1000. Additionally, when the ratio of the area in which the via electrodes 151b and 152b contact the surfaces 3 and 4 of the body 100 opposing each other in the second direction, as compared to the area of the surfaces 3 and 4 of the body 100 opposing each other in the second direction, is more than 65%, the via electrodes 151b and 152b may act as a penetration path of external moisture or oxygen, which may deteriorate moisture resistance reliability of the multilayer electronic component 1000.

Accordingly, in an example embodiment, the ratio of the area in which the via electrodes 151b and 152b contact the surfaces 3 and 4 of the body 100 opposing each other in the second direction, as compared to the area of the surfaces 3 and 4 of the body 100 opposing each other in the second direction, may be controlled to be 15% or more and 65% or less, thereby securing sufficient ESR characteristics of the multilayer electronic component 1000 as well as suppressing a decrease in moisture resistance reliability.

On the other hand, the ratio of the area in which the via electrodes 151b and 152b contact the surfaces 3 and 4 of the body 100 opposing each other in the second direction, as compared to the area of the surfaces 3 and 4 of the body 100 opposing each other in the second direction, may be controlled by adjusting diameters of the via electrodes 151b and 152b.

The ratio of (i) the area in which the via electrodes 151b and 152b contact the surfaces 3 and 4 of the body 100 opposing each other in the second direction, as compared to (ii) the area of the surfaces 3 and 4 of the body 100 opposing each other in the second direction may be obtained by measuring (i) and (ii) using a scanning electron microscope (SEM) and an image analysis software. Other methods and/or tools appreciated by one of ordinary skill in the art, even if not described in the present disclosure, may also be used.

In FIG. 6, the via electrodes 151b and 152b may be illustrated as being disposed in the center of the body 100 in the first direction, but in the present disclosure, the positions of the via electrodes 151b and 152b may vary depending on the purpose. Specifically, in an example embodiment, when the surfaces of the body 100 opposing each other in the first direction are referred to as the first and second surfaces 1 and 2, respectively, the via electrodes 151b and 152b may be disposed to be biased to one of the first surface and the second surface 1 and 2. Accordingly, the penetration path of external moisture may be improved to further improve the humidity resistance reliability of the multilayer electronic component 1000.

Additionally, in an example embodiment, the via electrodes 151b and 152b may include a first via electrode 151b in contact with the third surface 3 and a second via electrode 152b in contact with the fourth surface 4, and the first via electrode 151b may be disposed to be biased to the first surface 1, and the second via electrode 152b may be disposed to be biased to the second surface 2.

In an example embodiment, the via electrodes 151b and 152b may be spaced apart from the surfaces 1 and 2 of the body 100 opposing each other in the first direction and the surfaces 5 and 6 of the body 100 opposing each other in the third direction. Accordingly, the penetration path of external moisture or oxygen to the first to sixth surfaces may be blocked, and the humidity resistance reliability of the multilayer electronic component 1000 may be further improved.

Referring to FIG. 8, in an example embodiment, the connection electrodes 141 and 142 may cover one ends of the internal electrodes 121 and 122 in the second direction. Specifically, the connection electrodes 141 and 142 may be disposed to cover ends of the internal electrodes 121 and 122 exposed on the surfaces of the stack unit 110 opposing each other in the second direction. Accordingly, a contact area between the internal electrodes 121 and 122 and the connection electrodes 141 and 142 may be increased to further improve the ESR characteristics of the multilayer electronic component 1000.

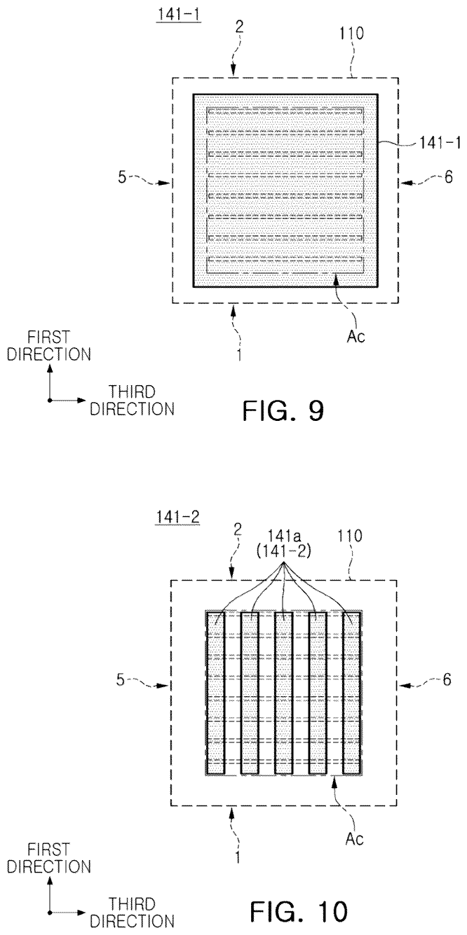

FIG. 9 is a plan view schematically illustrating a structure of a connection electrode according to an example embodiment.

FIG. 10 is a plan view schematically illustrating a structure of a connection electrode according to an example embodiment.

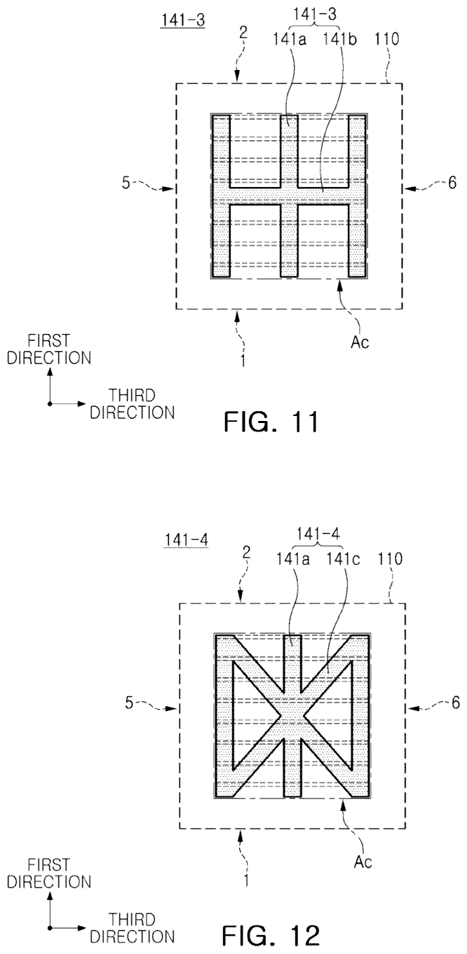

FIG. 11 is a plan view schematically illustrating a structure of a connection electrode according to an example embodiment.

FIG. 12 is a plan view schematically illustrating a structure of a connection electrode according to an example embodiment.

In an example embodiment, the connection electrodes 141 and 142 may cover portions of the cover portions 112 and 113.

Referring to FIG. 9, a connection electrode 141-1 may be disposed to not only cover the capacitance formation portion Ac, but also extend in the first direction or the third direction beyond the capacitance formation portion Ac.

Referring to FIG. 6, since the cover portions 112 and 113 are disposed on one surface and the other surface of the capacitance formation portion Ac in the first direction, the connection electrode 141-1 may cover portions of the cover portions 112 and 113. Accordingly, the connection between the connection electrodes 141 and 142 and the internal electrodes 121 and 122 may be secured, and bonding strength between the stack unit 110 and the connection electrodes 141 and 142 may be improved.

Referring to FIG. 10, a connection electrode 141-2 may include a plurality of body portions 141a disposed to contact one end of the internal electrode in the second direction but spaced apart from each other. A direction in which the plurality of body portions 141a are spaced apart from each other is not particularly limited, and the plurality of body portions 141a may be spaced apart from each other in the first direction and/or the third direction. Accordingly, as compared to a case in which the connection electrodes 141 and 142 entirely cover the ends of the internal electrodes 121 and 122 in the second direction, the moisture resistance of the multilayer electronic component 1000 may be improved.

Referring to FIG. 11, the connection electrode 141-3 may include a plurality of body portions 141a disposed contact one end of the internal electrode in the second direction but spaced apart from each other, and a connection portion 141b connecting a plurality of body portions 141a. Accordingly, the connection between the internal electrode and the connection electrode may be improved by integrally connecting the plurality of body portions 141a spaced apart from each other.

Referring to FIG. 12, the connection electrode 141-4 may include a plurality of body portions 141a disposed to contact one end of the internal electrode in the second direction but spaced apart from each other, and a connection portion 141c connecting the plurality of body portions 141a, and the connection portions 141c may be disposed in plural, and a plurality of connection portions 141c may be connected to each other. Accordingly, the plurality of body portions 141a spaced apart from each other may be integrally connected to each other, thereby further improving the connection between the internal electrode and the connection electrode.

Although the example embodiment of the present disclosure has been described in detail above, the present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ used in the present disclosure does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the terms are merely used to describe a specific embodiment, and are not intended to limit the present disclosure. Singular forms may include plural forms as well unless the context clearly indicates otherwise.

What is claimed is:

1. A multilayer electronic component, comprising:
a body including:
a stack unit including a dielectric layer and internal electrodes alternately arranged in a first direction with the dielectric layer interposed therebetween, when a direction, perpendicular to the first direction, is referred to as a second direction, and a direction perpendicular to the first direction and the second direction, is referred to as a third direction,
a connection electrode disposed on surfaces of the stack unit opposing each other in the second direction and in contact with the internal electrode, and
an extension unit disposed on the connection electrode and including an insulating layer; and
external electrodes disposed on the body,
wherein the extension unit further includes a via electrode in contact with at least a portion of the connection electrode and the external electrode.

2. The multilayer electronic component according to claim 1, wherein the connection electrode is spaced apart from one or more surfaces selected from surfaces of the body opposing each other in the first direction and surfaces of the body opposing each other in the third direction.

3. The multilayer electronic component according to claim 1, wherein the connection electrode is spaced apart from surfaces of the body opposing each other in the first direction and surfaces of the body opposing each other in the third direction.

4. The multilayer electronic component according to claim 1, wherein the extension unit includes a plurality of the via electrode.

5. The multilayer electronic component according to claim 1, wherein a ratio of an area in which the via electrode contact surfaces of the body opposing each other in the second direction, as compared to an area of the surfaces of the body opposing each other in the second direction, is 15% or more and 65% or less.

6. The multilayer electronic component according to claim 1, wherein when surfaces of the body opposing each other in the first direction are referred to as a first surface and a second surface, respectively, the via electrode is disposed to be closer to one of the first surface and the second surface than to the other of the first surface and the second surface.

7. The multilayer electronic component according to claim 1, wherein when surfaces of the body opposing each other in the first direction are referred to as a first surface and a second surface, respectively, and surfaces of the body opposing each other in the second direction are referred to as a third surface and a fourth surface, respectively, the via electrode includes a first via electrode in contact with the third surface and a second via electrode in contact with the fourth surface, and
the first via electrode is disposed to be closer to the first surface than to the second surface, and the second via electrode is disposed to be closer to the second surface than to the first surface.

8. The multilayer electronic component according to claim 1, wherein the via electrode is spaced apart from surfaces of the body opposing each other in the first direction and surfaces of the body opposing each other in the third direction.

9. The multilayer electronic component according to claim 1, wherein the connection electrode covers one end of the internal electrodes in the second direction.

10. The multilayer electronic component according to claim 1, wherein in the stack unit, when a region in which the internal electrodes overlap each other in the first direction is referred to as a capacitance formation portion, and regions disposed on a first surface and a second surface of the capacitance formation portion in the first direction are referred to as cover portions, and
the connection electrode covers portions of the cover portions.

11. The multilayer electronic component according to claim 1, wherein the connection electrode includes a plurality of body portions disposed to contact one end of the internal electrodes in the second direction and spaced apart from each other.

12. The multilayer electronic component according to claim 11, wherein the connection electrode further includes a connection portion connecting the plurality of body portions.

13. The multilayer electronic component according to claim 11, wherein the plurality of body portions includes three or more body portions.

14. The multilayer electronic component according to claim 1, wherein an entirety of the connection electrode is spaced apart from the external electrodes.

15. The multilayer electronic component according to claim 12, wherein the connection portion intersects at least one body portion among the plurality of body portions.

16. The multilayer electronic component according to claim 12, wherein the connection portion includes a first connection portion and a second connection portion.

17. The multilayer electronic component according to claim 16, wherein the first connection portion and the second connection portion intersect each other.
